(19) United States
(12) Patent Application Publication
(10) Pub. No.: US 2023/0297942 A1
(43) Pub. Date: Sep. 21, 2023

(54) System and Method of Providing a Secure Parcel Service

(71) Applicant: Joginder Singh Sidhu, Arleta, CA (US)

(72) Inventor: Joginder Singh Sidhu, Arleta, CA (US)

(21) Appl. No.: 18/323,314

(22) Filed: May 24, 2023

Related U.S. Application Data
(63) Continuation-in-part of application No. 16/391,099, filed on Apr. 22, 2019, now abandoned.
(60) Provisional application No. 62/660,728, filed on Apr. 20, 2018.

(51) Int. Cl. G06Q 10/0836

(52) U.S. Cl. CPC G06Q 10/0836

(57) ABSTRACT

A system and method of providing a secure parcel service allows a user with a consumer account to select a secure drop-off location in order to prevent his or her package from being lost, stolen, or damaged after the delivery process. Moreover, the method allows a user with a repository account to provide his or her property to be used as a secure drop-off location. The method allows a user with a consumer account to provide package-handling logistics which instructs a user with a repository account on how to handle the package after the package has been delivered to the secure drop-off location. Additionally, the method allows a user with a repository account provide detailed information such as at least one drop-off location and his or her availability to receive a package. The method also performs a background check on users attempting to create a new repository account.

The current application is a continuation application of the U.S. non-provisional application Ser. No. 16,391/099 filed on Apr. 22, 2019. The U.S. non-provisional application 16,391/099 claims a priority to the U.S. Provisional Patent application Ser. No. 62/660,728 filed on Apr. 20, 2018. The current application is filed on Apr. 22, 2019 while Apr. 20, 2019 was on a weekend.

### FIELD OF THE INVENTION

The present invention generally relates to shipping systems and methods. More specifically, the present invention is a system and method of providing a secure parcel service which allows users to provide secure drop-off locations and allow consumers to choose the secure drop-off locations.

### BACKGROUND OF THE INVENTION

Nowadays, thousands of purchases are made online which results in thousands of packages being delivered throughout the world. Currently, most of the parcels and packages shipped are dropped off in front of residences or buildings. Unfortunately, thousands of delivered packages are stolen or damaged as the packages are left outdoors, which leave them exposed to the weather and left unprotected. To prevent packages from being stolen or damaged, many shipping companies provide lockers where packages can be delivered and can be located at various publicly accessible locations such as stores, parks, shopping centers, etc. These lockers can hold the packages until the recipients of the packages can pick up the packages, and only the recipients can access the lockers. While these lockers provide a good solution to leave the packages in a protected, safe location, these lockers are costly to manufacture and to install. The use of the lockers still requires recipients to pick up the delivered packages at their location, which can be far from the recipients' home and makes the process inconvenient. In addition, these lockers force shipping companies to pay or rent for the space where the lockers are installed, so few locations are often available to users, and sometimes no locations are available at all in remote locations. Furthermore, newer shipping technologies such as drone delivery are not compatible with these solutions, which leaves packages delivered by these new methods exposed and unprotected outside residential and commercial locations. Therefore, secure drop-off locations for shipping and delivery services are beneficial and necessary to overcome the limitations of existing delivery locations, such as lockers.

An objective of the present invention is to provide secure drop-off locations for shipping and delivery services. The secure drop-off locations are preferably on-demand locations where packages, parcels, etc., can be safely delivered. The secure drop-off locations can include designated residential locations or commercial locations which are vetted and/or insured in order to provide the users with a trustworthy and reliable location to receive their deliveries. The secure drop-off locations prevent packages and/or parcels from getting stolen or damaged by the weather. The secure drop-off locations can be provided as an option available through the delivery services or can be provided by the users to the delivery services as the requested delivery location. In the preferred embodiment of the present invention, the secure drop-off locations can be provided on-demand through a software application. In alternate embodiments of the present invention, the secure drop-off locations can be requested through the shipping/delivery services' websites and/or applications. The present invention can allow users to have an additional source of income by allowing their location, such as home, business, etc., to be used as a secure drop-off location. In alternate embodiments of the present invention, the present invention can further serve as secure pick-up locations where packages, parcel, etc., can be picked up by shipping/delivery services.

### BRIEF DESCRIPTION OF THE DRAWINGS

FIG. 1 is a block diagram illustrating the system of the present invention.

FIG. 2A is a flowchart illustrating the overall method of the present invention.

FIG. 2B is a continuation of the flowchart from FIG. 2A.

FIG. 3 is a flowchart illustrating the subprocess that allows a repository account to enter details of the drop-off information.

FIG. 4 is a flowchart illustrating the subprocess that retrieves the drop-off location of a repository account with a GPS module.

FIG. 5 is a flowchart illustrating the subprocess that displays drop-off information for each nearby account to a consumer account.

FIG. 6 is a flowchart illustrating the subprocess that retrieves a current location of a consumer account with a GPS module.

FIG. 7 is a flowchart illustrating the subprocess that allows a consumer account to communicate with a repository account.

FIG. 8 is a flowchart illustrating the subprocess that allows a user to create a new repository account.

FIG. 9 is a flowchart illustrating the subprocess that allows a repository account to confirm or deny a delivery request.

FIG. 10 is a flowchart illustrating the subprocess that allows a consumer account to enter details of the package-handling logistics.

FIG. 11 is a flowchart illustrating the subprocess that integrates the present invention into an online shopping platform.

### DETAIL DESCRIPTIONS OF THE INVENTION

All illustrations of the drawings are for the purpose of describing selected versions of the present invention and are not intended to limit the scope of the present invention.

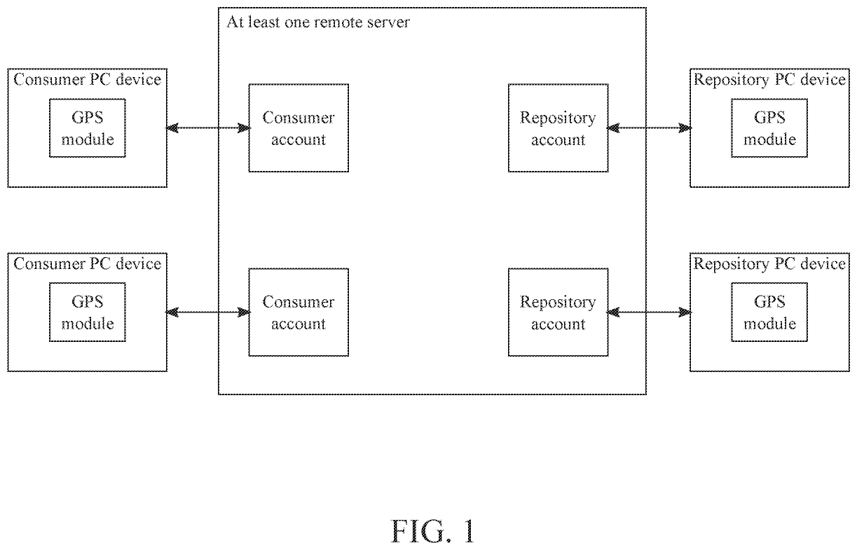

In reference to FIGS. 1 to 11, the present invention is a system and method of providing a secure parcel service. In further detail, the present invention is a platform where a consumer can choose a secure drop-off location from a set of secure drop-off locations which is provided by users that own said secure drop-off locations. The present invention's main objective is to prevent a consumer's package from being lost, damaged, or stolen by providing secure drop-off locations where the package can be safely handled. With reference to FIG. 1, the system of the present invention includes at least one remote server. The remote server is used to manage a plurality of consumer accounts (Step A) and a plurality of repository accounts (Step B). Moreover, the remote server is used as a hub to exchange information between the plurality of consumer account and the plurality of repository accounts, to store data provided the plurality of consumer accounts and the plurality of repository accounts, and to manage the administrative processes of the present invention. The plurality of consumer accounts is a set of user accounts available to users that want to use secure drop-off locations. The plurality of repository accounts is a set of user accounts available to users that want to provide secure drop-off locations. A secure drop-off location is any location where a package can be stored in order to prevent the package from being lost, stolen, or damaged. Each consumer account is associated with a corresponding consumer personal computing (PC) device. The consumer PC device may be any computing device such as, but not limited to, a desktop computer, a smartphone, a mobile device, or an electronic tablet. Similarly, each repository account is associated with a corresponding repository PC device and includes drop-off information. The repository PC device may any type of computing device such as, but not limited to, a desktop computer, a smartphone, a mobile device, or an electronic tablet. The drop-off information is a set of information that includes information such as, but not limited to, the physical address of a secure drop-off location provided the corresponding repository account.

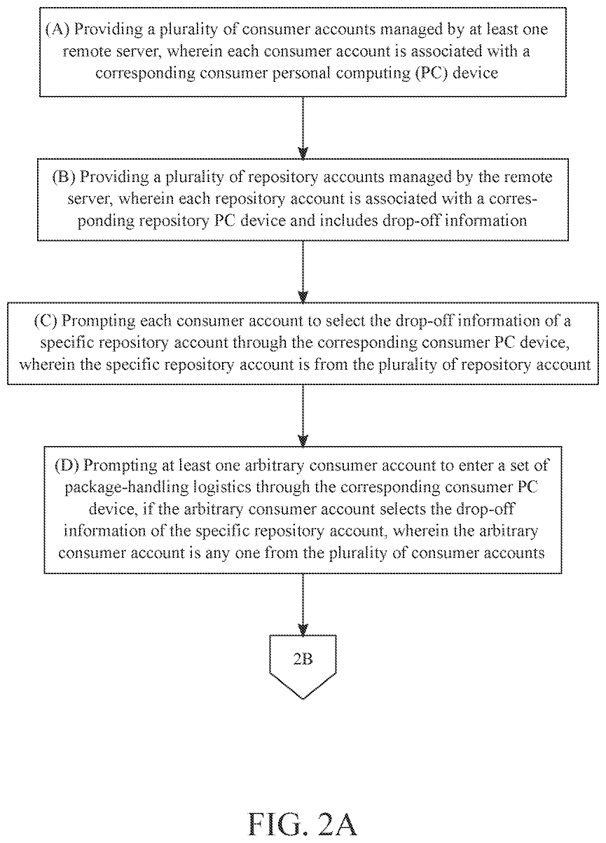

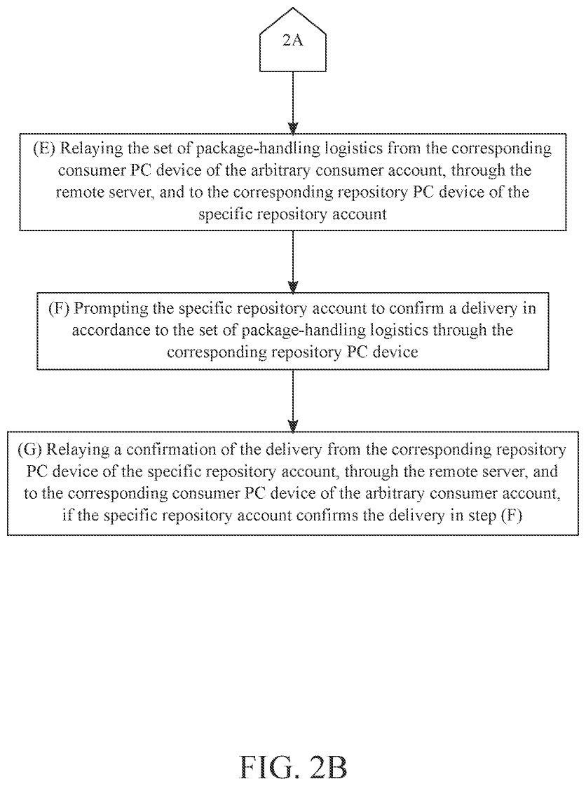

With reference to FIGS. 2A and 2B, the method of the present invention follows an overall process that allows a consumer to choose a secure drop-off location for a delivery and for a user to provide a secure drop-off location. The corresponding consumer PC device prompts each consumer account to select the drop-off information of a specific repository account (Step C). The specific repository account is from the plurality of repository accounts. When each consumer account is prompted, the drop-off information is preferably displayed on the corresponding consumer PC device in a list format. The corresponding consumer PC device prompts at least one arbitrary consumer account to enter a set of package-handling logistics, if the arbitrary consumer account selects the drop-off information of the specific repository account (Step D). The arbitrary consumer account is any one from the plurality of consumer accounts. The set of package-handling logistics is information including, but not limited to, how a package should be handled and whether to hold onto the package or deliver the package. The set of package-handling logistics is relayed from the corresponding consumer PC device of the arbitrary consumer account, through the remote server, and to the corresponding repository PC device of the specific repository account (Step E). The set of package-handling logistics is preferably displayed on the corresponding repository PC device of the specific repository account in a text format. The corresponding repository PC device prompts the specific repository account to confirm a delivery in accordance to the set of package-handling logistics (Step F). In further detail a confirm or reject option, which includes the set of package-handling logistics, is displayed on the corresponding repository PC device. The delivery is an agreement to receive a package intended for the user of the arbitrary consumer account and to follow the package-handling logistics. A confirmation of the delivery is relayed from the corresponding repository PC device of the specific repository account, through the remote server, and to the corresponding consumer PC device of the arbitrary consumer account (Step G). This step is processed if the specific repository account confirms the delivery in Step F. The confirmation of the delivery starts the process of transporting the package to the drop-off information of the specific repository account. If the specific repository account rejects the delivery, the arbitrary consumer account is prompted to select the drop-off information of another repository account.

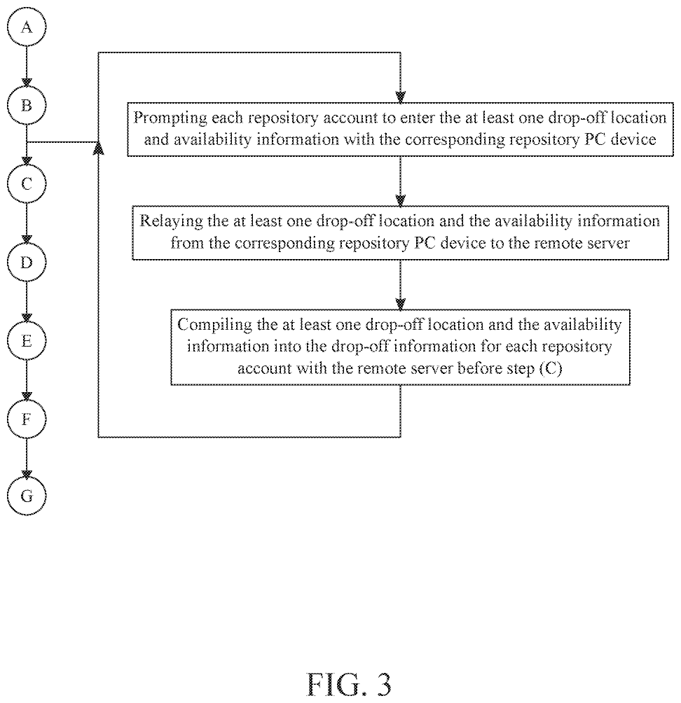

In order for each repository account to specify details of the drop-off information and with reference to FIG. 3, the corresponding repository PC device prompts each repository account to enter at least one drop-off location and availability information. The at least one drop-off location includes at least one physical address of a secure area where one can receive a package. For example, the at least one drop-off location can be any location such as, but not limited to, a house, a storage locker, or a warehouse owned by a user of a repository account. The availability information is information that includes days and hours when a user with a repository account is available to receive a package. The at least one drop-off location and the availability information is relayed from the corresponding repository PC device to the remote server in order to properly store the provided information from the user with a repository account. The at least one drop-off location and the availability information is compiled into the drop-off information for each repository account with the remote server before Step C. This details what is included into the drop-off information in order for a consumer account to confidently select a drop-off information of a repository account.

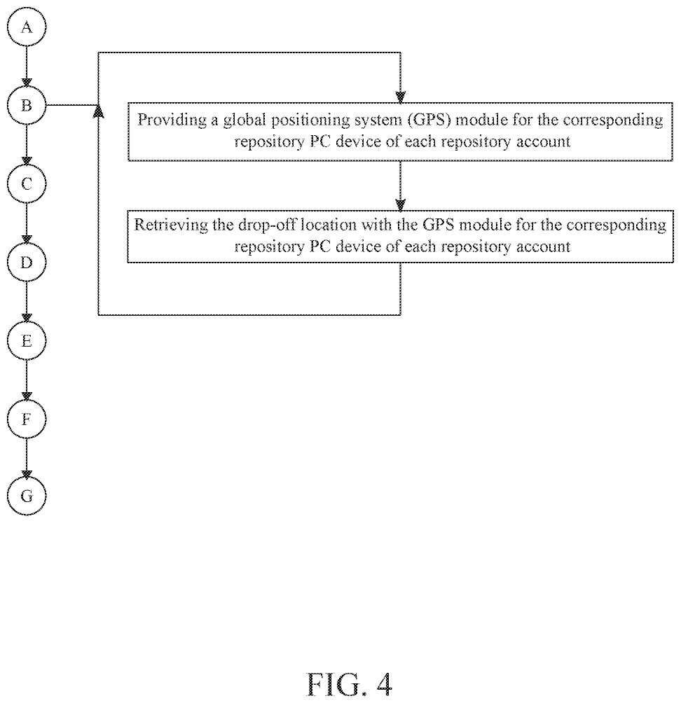

With reference to FIG. 4, a global positioning system (GPS) module is provided for the corresponding repository PC device of each repository account. The GPS module is preferably integrated into the corresponding repository PC device of each repository account. The drop-off location is retrieved with the GPS module for the corresponding repository PC device of each repository account. This step aggregates the drop-off locations of each repository account in order to display a list of nearby drop-off locations to each consumer account.

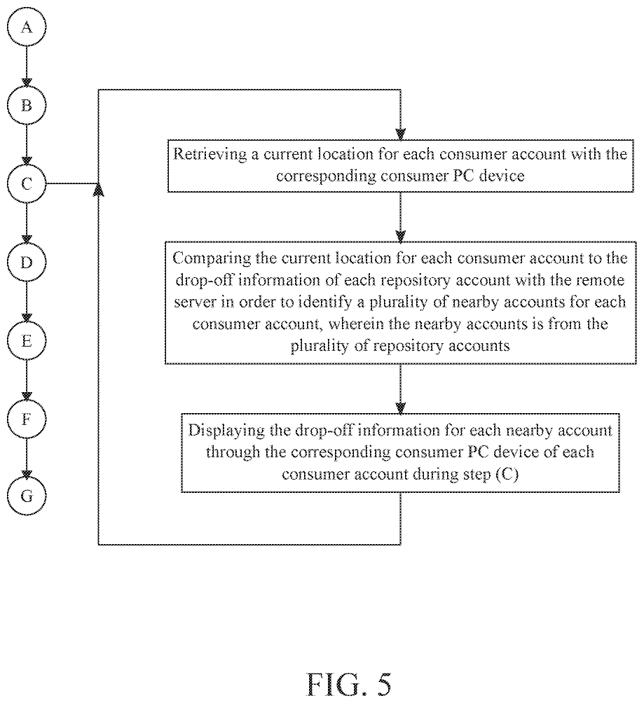

In order to display a list of nearby secure drop-off locations relative to each consumer account and with reference to FIG. 5, a current location for each consumer account is retrieved with the consumer PC device. The current location is a physical address that is inputted by each consumer account or can be retrieved using another method. The current location for each consumer account is compared to the drop-off information of each repository account with the remote server in order to identify a plurality of nearby accounts for each consumer account. The plurality of nearby accounts is from the plurality of repository accounts. The plurality of nearby accounts is a set of accounts owned by users who are physically positioned near each consumer account. The drop-off information for each nearby account is displayed through the corresponding consumer PC device of each consumer account during Step C. This step allows a user with a consumer account to select a drop-off information which is convenient in terms of physical distance relative to the user. The drop-off information for each nearby account is preferably displayed in a list format.

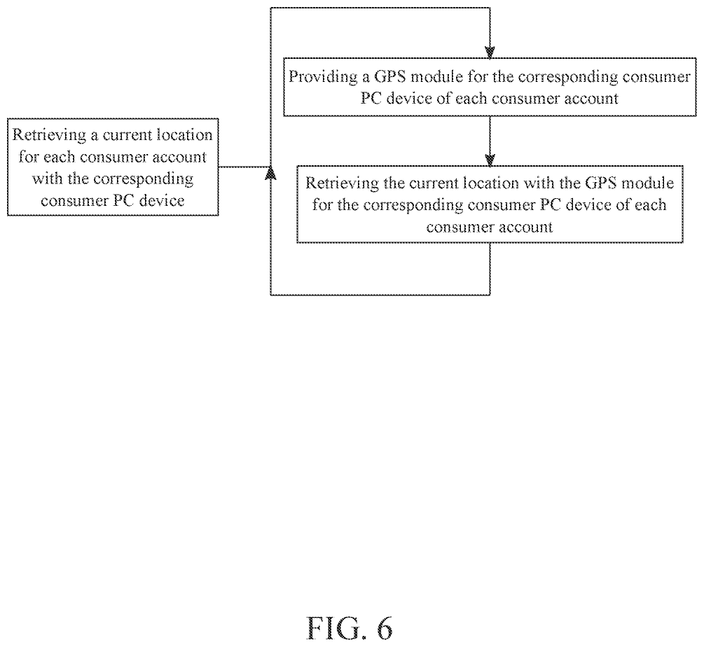

In order to automatically retrieve the current location for each consumer account and with reference to FIG. 6, a GPS module is provided for the corresponding consumer PC device of each consumer account. The GPS module is preferably integrated into the corresponding consumer PC device of each consumer account. The current location is retrieved with the GPS module for the corresponding consumer PC device of each consumer account. This step allows the current location to be automatically retrieved in order to conveniently display nearby accounts to each consumer account.

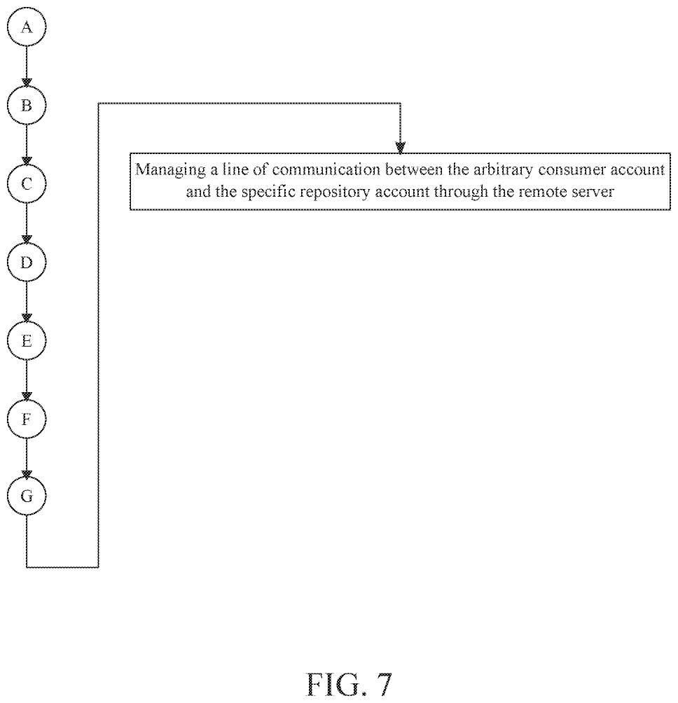

After a delivery is confirmed between the arbitrary consumer account and the specific repository account and with reference to FIG. 7, a line of communication is managed between the arbitrary consumer account and the specific repository account through the remote server. This step allows the arbitrary consumer account and the specific repository account to verify and further discuss details of the package-handling logistics. Additionally, the arbitrary consumer account is able to communicate additional instructions or make changes to the package-handling logistics through the line of communication. Moreover, the specific repository account can update the arbitrary consumer account when the package has been delivered.

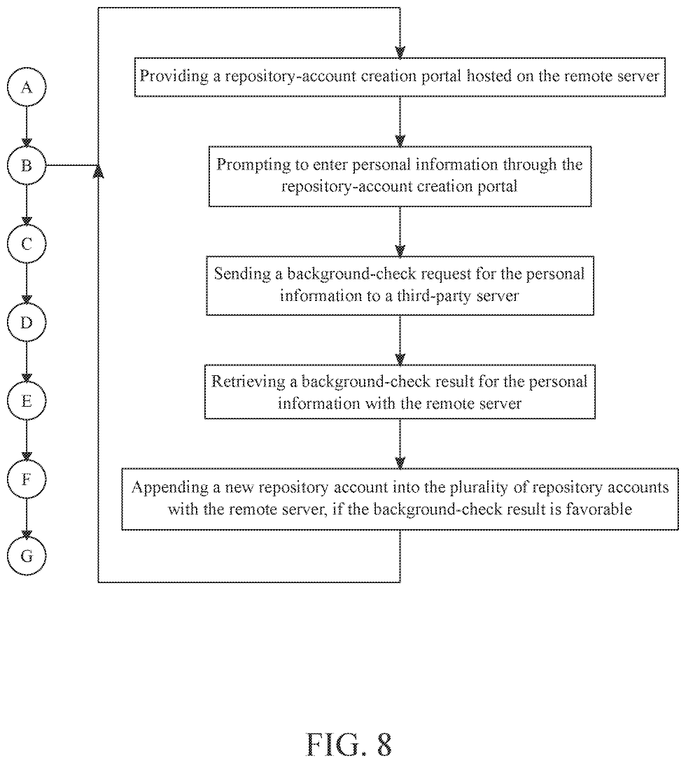

In order to create a new repository account and with reference to FIG. 8, a repository-account creation portal is hosted on the remote server. The repository-account creation portal is a platform of the present invention that allows users to create a repository account. The repository-account creation portal prompts to enter personal information. The personal information may be any type of information including, but not limited to, a name, a phone number, an email address, a physical address, and a social security number. A background-check request for the personal information is sent to a third-party server. This step is processed if the personal information is entered through the repository-account creation portal. The background-check request is required to ensure the safety of the users with a consumer account when interacting with users with a repository account. A background-check result for the personal information is retrieved with the remote server. The background-check result is a set of information that displays any negative history of a user attempting to create a repository account. A new repository account is appended into the plurality of repository accounts with the remote server, if the background-check result is favorable. As mentioned previously, this subprocess ensures the safety of the users with consumer accounts. If the background-check result is not favorable, the user creating a repository account is not granted a new repository account.

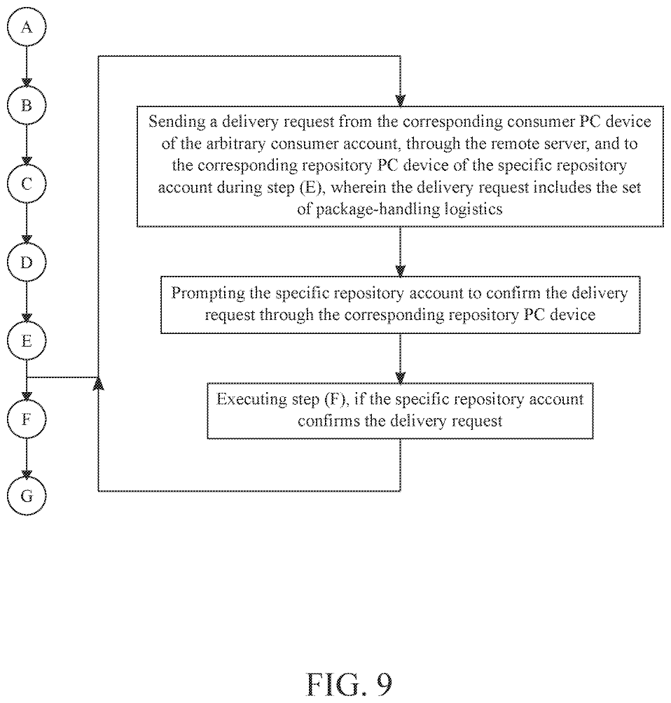

In order for the specific repository account to confirm or reject the delivery and with reference to FIG. 9, a delivery request is sent from the corresponding consumer PC device of the arbitrary consumer account, through the remote server, and to the corresponding repository PC device of the specific repository account during Step E, wherein the delivery request includes the set of package-handling logistics. The delivery request notifies the specific repository account that his or her drop-off location has been selected. The corresponding repository PC device then prompts the specific repository account to confirm the delivery request. This step allows the specific repository account to confirm or reject the delivery based on the set of package-handling logistics. Step F is executed if the specific repository account confirms the delivery request. In further detail, the set of package-handling logistics is favorable to the specific repository account. If the set of package-handling logistics is not favorable to the specific repository account, the delivery request can be rejected, and the arbitrary consumer account is prompted to select the drop-off information of another repository account.

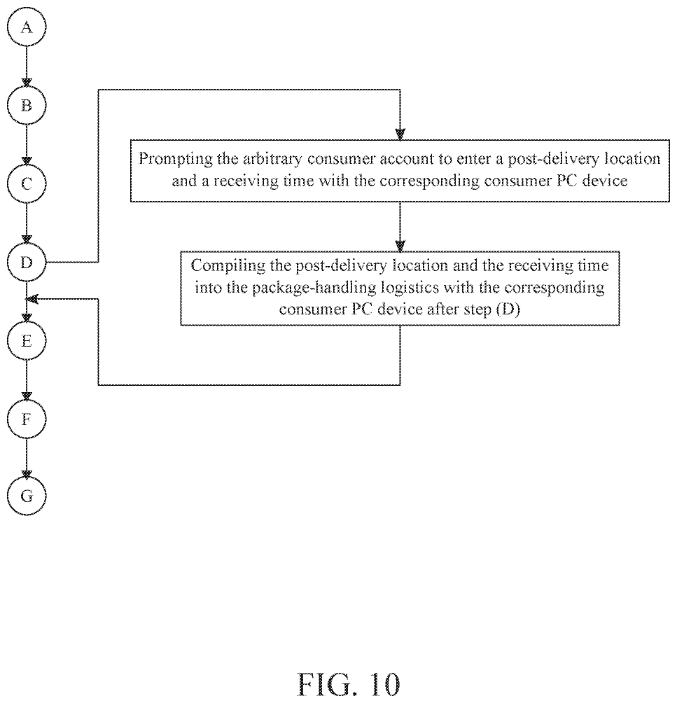

In order for the arbitrary consumer account to detail the set of package-handling logistics and with reference to FIG. 10, the arbitrary consumer account is prompted to enter a post-delivery location and a receiving time with the corresponding consumer PC device. If the user of arbitrary consumer account requests to have the package delivered to him or her after it the package has been received by the user of the specific repository account, the post-delivery location and the receiving time are entered. The post-delivery location may be any physical address that the user of the arbitrary consumer account wants to specify. The receiving time is a specified time and day when the user of the arbitrary consumer account is available to receive the package from the user of the specific repository account. The post-delivery location and the receiving time are compiled into the set of package-handling logistics with the corresponding consumer PC device after Step D. This step allows the user of the specific repository account to be fully aware of the requests from the user of the arbitrary consumer account.

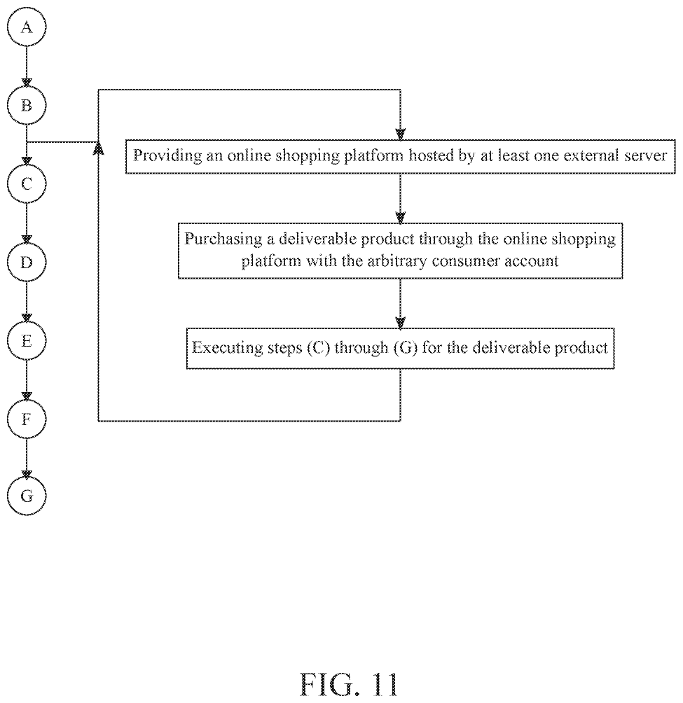

In order the present invention to be integrated into platforms of online vendors and with reference to FIG. 11, an online shopping platform is hosted by at least one external server. The online shopping platform can be any platform of any online vendor that uses a shipping service. A deliverable product is purchased through the online shopping platform with the arbitrary consumer account. The deliverable product can be any product that is able to be shipped to a specified location. Steps C through G are executed for the deliverable product. This step allows the deliverable product to be shipped to a secure drop-off location which further prevents the deliverable product from being lost, damaged, or stolen.

Although the invention has been explained in relation to its preferred embodiment, it is to be understood that many other possible modifications and variations can be made without departing from the spirit and scope of the invention as hereinafter claimed.

What is claimed is:

1. A method of providing a secure parcel service, the method comprises the steps of:
(A) providing a plurality of consumer accounts managed by at least one remote server, wherein each consumer account is associated with a corresponding consumer personal computing (PC) device;
(B) providing a plurality of repository accounts managed by the remote server, wherein each repository account is associated with a corresponding repository PC device and includes drop-off information, and wherein the plurality of repository accounts and the plurality of consumer accounts are separate and distinct groups of user accounts;
(C) prompting each consumer account to select the drop-off information of a specific repository account through the corresponding consumer PC device, wherein the specific repository account is from the plurality of repository account;
(D) prompting at least one arbitrary consumer account to enter a set of package-handling logistics through the corresponding consumer PC device, if the arbitrary consumer account selects the drop-off information of the specific repository account, wherein the arbitrary consumer account is any one from the plurality of consumer accounts;
(E) relaying the set of package-handling logistics from the corresponding consumer PC device of the arbitrary consumer account, through the remote server, and to the corresponding repository PC device of the specific repository account;
(F) prompting the specific repository account to confirm a delivery in accordance to the set of package-handling logistics through the corresponding repository PC device; and
(G) relaying a confirmation of the delivery from the corresponding repository PC device of the specific repository account, through the remote server, and to the corresponding consumer PC device of the arbitrary consumer account, if the specific repository account confirms the delivery in step (F);
sequentially executing steps (C) through (G);
retrieving a current location for each consumer account with the corresponding consumer PC device;
comparing the current location for each consumer account to the drop-off information of each repository account with the remote server in order to identify a plurality of nearby accounts for each consumer account, wherein the nearby accounts is from the plurality of repository accounts;
displaying the drop-off information for each nearby account through the corresponding consumer PC device of each consumer account during step (C);
prompting the arbitrary consumer account to enter a post-delivery location and a receiving time with the corresponding consumer PC device; and
compiling the post-delivery location and the receiving time into the package-handling logistics with the corresponding consumer PC device after step (D).

2. The method of providing a secure parcel service as claimed in claim 1 comprises the steps of:
prompting each repository account to enter the at least one drop-off location and availability information with the corresponding repository PC device;
relaying the at least one drop-off location and the availability information from the corresponding repository PC device to the remote server; and
compiling the at least one drop-off location and the availability information into the drop-off information for each repository account with the remote server before step (C).

3. The method of providing a secure parcel service as claimed in claim 2 comprises the steps of:
providing a global positioning system (GPS) module for the corresponding repository PC device of each repository account; and
retrieving the drop-off location with the GPS module for the corresponding repository PC device of each repository account.

4. The method of providing a secure parcel service as claimed in claim 1 comprises the steps of:
providing a GPS module for the corresponding consumer PC device of each consumer account; and
retrieving the current location with the GPS module for the corresponding consumer PC device of each consumer account.

5. The method of providing a secure parcel service as claimed in claim 1 comprises the step of:
managing a line of communication between the arbitrary consumer account and the specific repository account through the remote server.

6. The method of providing a secure parcel service as claimed in claim 1 comprises the steps of:
providing a repository-account creation portal hosted on the remote server;
prompting to enter personal information through the repository-account creation portal;
sending a background-check request for the personal information to a third-party server, if the personal information is entered through the repository-account creation portal;
retrieving a background-check result for the personal information with the remote server; and
appending a new repository account into the plurality of repository accounts with the remote server, if the background-check result is favorable.

7. The method of providing a secure parcel service as claimed in claim 1 comprises the steps of:
sending a delivery request from the corresponding consumer PC device of the arbitrary consumer account, through the remote server, and to the corresponding repository PC device of the specific repository account during step (E), wherein the delivery request includes the set of package-handling logistics;
prompting the specific repository account to confirm the delivery request through the corresponding repository PC device; and
executing step (F), if the specific repository account confirms the delivery request.

8. The method of providing a secure parcel service as claimed in claim 1 comprises the steps of:
providing an online shopping platform hosted by at least one external server;
purchasing a deliverable product through the online shopping platform with the arbitrary consumer account; and
executing steps (C) through (G) for the deliverable product.
